(19) United States
(12) Patent Application Publication
(10) Pub. No.: US 2016/0266785 A1
(43) Pub. Date: Sep. 15, 2016

(54) Method To Automatically And Selectively Mask End User Controls In HTML Rendered Content

(71) Applicant: Scannx, Inc., Pleasanton, CA (US)

(72) Inventors: Ron van Os, Boulder, CO (US); Murray Dennis, Pleasanton, CA (US); John Dexter, Richmond, VA (US)

(73) Assignee: Scannx, Inc., Pleasanton, CA (US)

(21) Appl. No.: 15/065,831

(22) Filed: Mar. 9, 2016

Related U.S. Application Data
(60) Provisional application No. 62/177,172, filed on Mar. 9, 2015.

(51) Int. Cl. G06F 3/0484; G06F 3/0488

(52) U.S. Cl. CPC G06F 3/04847; G06F 3/0488

(57) ABSTRACT

Many software applications have the ability to render the application's user interface from content delivered by internet connected HTML servers. At times it is desirable to limit the amount of access the end user has to the rendered content. This inventive method is able to limit and guide the end user interaction within the HTML content, without requiring any changes to the delivered HTML content, or changes to the appearance of the rendered content. The look-and-feel of the content is preserved while ensuring the end user remains inside the software application intended boundary.

### CROSS REFERENCE TO RELATED APPLICATIONS

This application claims the benefit of U.S. Provisional Patent Application No. 62/177,172, filed on Mar. 9, 2015, and titled “Method To Automatically And Selectively Mask End User Controls In HTML Rendered Content” which is incorporated by reference herein in its entirety for all purposes.

### BACKGROUND OF THE INVENTION

### Field of the Invention

The present invention is in the technical field of computer graphical user interfaces. More particularly, the present invention pertains to the field of limiting a user's ability to interface with a graphical user interface.

### SUMMARY

The scope of the present invention is defined solely by the appended claims and detailed description of a preferred embodiment, and is not affected to any degree by the statements within this summary. In addressing many of the problems experienced in the related art, such as those relating to displaying interactive web content inside of an application display, the present disclosure generally involves a computerized method or computer system having a graphical user interface for limiting an end user's access to interactable elements displayed on a graphical user interface. The method or system renders a transparent software surface in front of the user interface that prevents user interaction with selectable interactable elements displayed on the user interface. The method or system also detects changes in the layout of said user interface and moves the selected areas of prevented interaction.

### BRIEF DESCRIPTION OF THE DRAWINGS

Various embodiments are described herein with reference to the following Drawings. Certain aspects of the Drawings are depicted in a simplified way for reason of clarity. Not all alternatives and options are shown in the Drawings and, therefore, the Claims are not limited in scope to the content of the Drawings.

1. FIGURES

FIG. 1 illustrates a computing device, equipped with a touch-enabled screen, in accordance with an embodiment of the present disclosure.

FIG. 2 illustrates a computing device, with the interface mask shown, in accordance with an embodiment of the present disclosure.

FIG. 3 illustrates depicts a computing device, with the interface mask shown including additional instructions for the device user, in accordance with an embodiment of the present disclosure.

### DETAILED DESCRIPTION

The following description is not to be taken in a limiting sense, but is made merely for the purpose of describing the general principles of exemplary embodiments, many additional embodiments of this invention are possible. It is understood that no limitation of the scope of the invention is thereby intended. The scope of the disclosure should be determined with reference to the Claims. Reference throughout this specification to “one embodiment,” “an embodiment,” or similar language means that a particular feature, structure, or characteristic that is described in connection with the embodiment is included in at least one embodiment of the present disclosure. Any alterations and further modifications in the illustrated devices, and such further application of the principles of the invention as illustrated herein are contemplated as would normally occur to one skilled in the art to which the invention relates.

For the purposes of promoting an understanding of the principles of the present invention, reference will now be made to the embodiments illustrated in the drawings and specific language will be used to describe the same.

A typical desktop computer, laptop, smart phone or tablet can contain many installed software applications. Many of these software applications have the ability to render a graphical user interface from content provided using internet web based standards like HTML (Hypertext Markup Language). The rendered user interface can be made responsive by utilizing established scripting languages like JS (Java Script), to handle user interactions on the local device. The content can either be installed with the application or delivered from an internet connected and accessible HTML server, via standard insecure HTTP (Hypertext Transfer Protocol) and secure HTTPS (HTTP over TLS (Transport Layer Security) or HTTP over SSL (Secure Sockets Layer) protocols.

As long as both the installed content, and the internet connected and accessible server delivered content, are provided by the application manufacturer/developer, full content control is available to ensure the end users stays within the application boundaries. Here the application boundary is defined as the end user experience intended and delivered by the application manufacturer/developer.

In many cases it is desirable to render content from a 3^{rd} party internet connected and accessible HTML server in the afore mentioned application, to enhance both functionality and end user experience. In this case there is little to no control over the actual HTML content provided by the 3^{rd} parties server, potentially causing the end user to leave the application boundary. In addition, the end user experience can be compromised due to the presence of undesired and confusing content.

The current invention in its preferred embodiment as described herein, is able to limit and guide the end user interaction with the 3^{rd} party internet connected and accessible HTML server content, without requiring any changes to the delivered HTML content. In addition, the 3^{rd} party HTML content is rendered and presented without any modification in appearance, avoiding potential conflicts relating to copyright infringements, and look-and-feel changes.

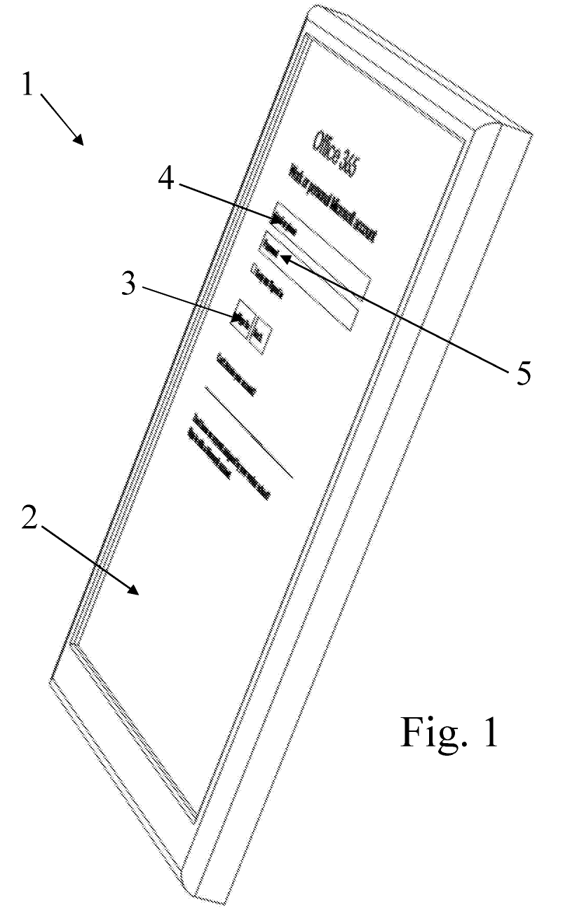

The user interaction with a desktop computer, laptop, smart phone, or tablet, typically involves the use of a selection and input device, such as: keyboard, a pointing device and/or a touch capable user interface rendering device. Referring to FIG. 1, where 1 represents a computing device containing a display rendering surface which shows the applications user interface 2. The user interface typically contains elements which enables the end user interaction. An example of an interaction element is a screen rendered button 3, which the end user can ‘press’, or a text entry field 4, where the user can enter or modify text.

Without a touch capable device screen, visual clues are rendered on the device screen to show the end user which of the interaction elements is active. For instance, a cursor 5 is showing the location of the pointing device touch point, and/or a focus rectangle around the screen rendered control element is shown indicating the active control on the device screen. All these clues help the end user navigate the user interface.

Once the end user has selected the element to interact with, the user touches it on the touch screen, clicks a button on the pointing device, or presses a button on the keyboard to activate the control element. Any of these use cases will result in the operation system software running on the device to become aware of the user interaction request, which is referred to as a touch or click event. The operating system software determines the active element from the location of the touch/click event on the device screen.

The software application running on the device that rendered the graphical user interface 2, will be sent the active element and touch/click event for handling of the user request. The software application will execute the user request on the device potentially updating the user interface 2 and wait for the next user request to occur.

If the rendered user interface was derived from content under the control of the application developer, this is the intended operation of the software application and no further changes are needed. On the other hand, if 3^{rd} party content, which is not under the control of the application developer, is rendered to the user interface, it is possible that user requests are being received that the application software cannot handle, or there could be user requests that make no sense for the software application to handle. In this case, it can be necessary to alter and or limit the effects of the user interaction with the rendered content.

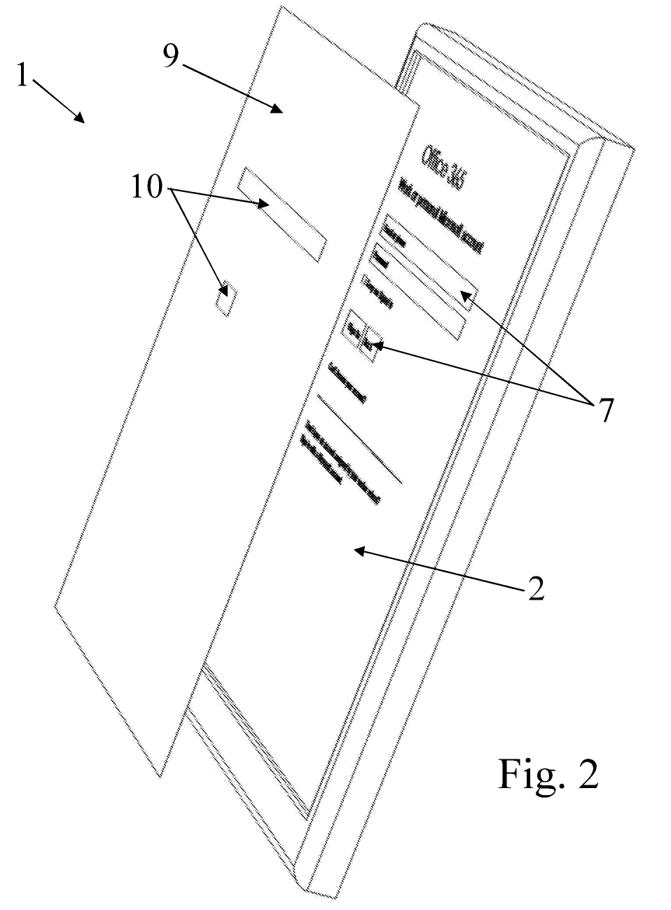

Referring to FIG. 2, where 1 represents a computing device containing a display rendering surface which shows the applications user interface 2. The rendered elements 7 which are determined to be the elements the end user should be allowed to interact with. Other active elements like textboxes, hyperlinks and buttons that are present in the user interface but are determined to be either a distraction or enable the user to leave the application boundary, should not be available to the end user.

To accomplish this, a transparent software surface 9 is rendered in front of the originally rendered content on the user interface 2, with areas of exclusion 10 where interaction with the rendered elements 7 on the user interface 2 is allowed (For clarity, in FIG. 2 the transparent software surface 9 is drawn in an exploded view, it is actually directly on top of the rendering of the user interface 2. This transparent software surface 9, effectively masks the original content, and only exposes end user accessible content in the areas covered by the transparent software surface 9, but does not make it interactable. From the end user's perspective, the content looks identical to the content rendered without mask 10 in place. The mask layer itself is a software construct that is able to receive user interactions and actively participates in the operating systems event handling.

If the end user has selected a ‘masked’ active element to interact with, and touches it on the touch screen, clicks a button on the pointing device, or presses a button on the keyboard to activate it, the operation system software will detect the user interaction input signal; and as before, the operating system determines the active element from the location of the user interaction input on the device screen; which in the case of a ‘masked’ element is the transparent software surface 9 itself. The user interaction input is sent to the software application creating the transparent software surface 9, instead of the HTML content, and the software application simply discards it. This effectively removes control from all active HTML elements that are under the mask, while retaining the original functionality for controls that are not masked.

The actual implementation of the software application is operating system and hardware dependent and requires the determination of the actual rendered location of the active elements, and the subsequent creation of the mask. One method to accomplish this uses HTML content pre-rendering, using any of the readily available HTML Browsers controls, like the Microsoft Trident Engine, or Web Kit derivatives. Once rendering completes, the active control locations are determined and a transparent software surface 9 is constructed. Subsequently the underlying masked Html rendering is presented in the user interface 2. The downside of this approach is that dynamic HTML user interfaces will not necessarily keep the location of the control elements in the same place, making this method unreliable.

The preferred implementation method relies on injecting JavaScript code prior to final rendering of the HTML content in the user interface. The primary task of the injected JavaScript is to determine the active control locations and relay that information to the software application. Once the locations have been determined and relayed, the application generates the transparent software surface 9 on top of the displayed user interface 2 HTML. When changes to the layout of the user interface 2 happen due to dynamic HTML activities, the injected JavaScript can be designed to detect the changes and relay it up to the application for dynamic adjustments to the transparent software surface 9.

For hardware with a modern touchscreen display, the mask can be implemented by determining and forwarding the no-touch zones, from the JavaScript determined active control locations, to the touch screen controller. In this case the operating system will not receive any user interaction input signals from the no-touch zones.

In a practical example the afore described method is used to show internet delivered content in a touch screen equipped KIOSK. In particular, the KIOSK application uses an embedded web browser, like the Microsoft Trident engine, or a Web Kit based browser, to show rendered web content to enable the end user to log into a third party service like Microsoft OneDrive to allow access to the user's cloud storage account. For providers of the KIOSK it is undesirable for the end user to be able to create a new account, reset a password, or browse other content due to the limited touch screen access, limited time allotment on the kiosk, and to prevent the user from browsing away from the intended work flow.

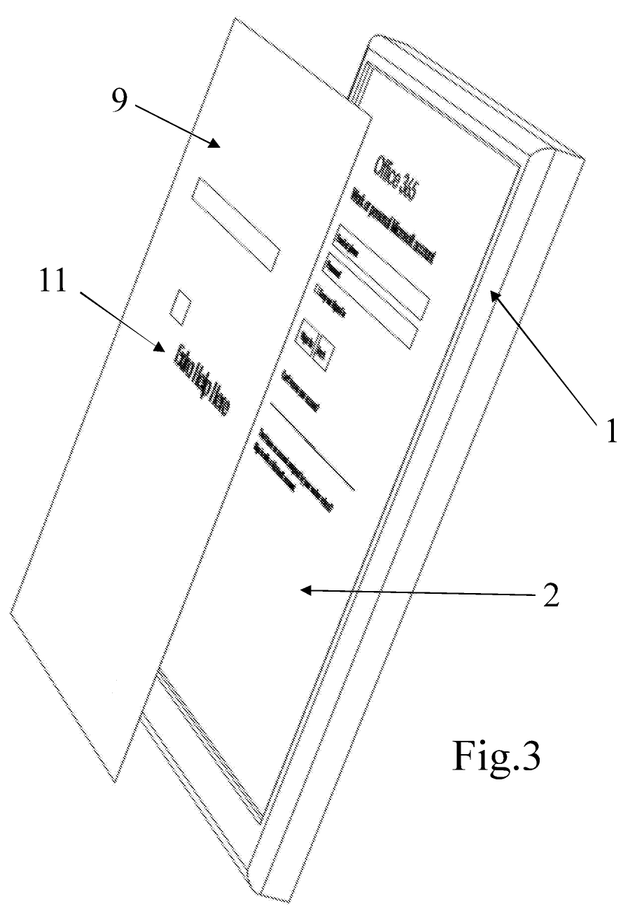

Referring to FIG. 3, where 1 represents a computing device containing a display rendering surface which shows the applications user interface 2 (For clarity, in FIG. 3 the transparent software surface mask 9 is drawn in an exploded view, it is actually directly on top of user interface 2). In this figure, additional non-transparent interactive elements 11 are rendered in the transparent software surface mask 9, such as: instructions, or a help button, which are then displayed over the underlying user interface 2. The instructions or help could be in the form of text as shown in the figure or a short instructional video.

The combination of limiting access and optionally providing guidance, will enable the application developer to re-use 3^{rd} party content while retaining control, and increase end user satisfaction.

Information as herein shown and described in detail is fully capable of attaining the above-described object of the present disclosure, the presently preferred embodiment of the present disclosure; and is, thus, representative of the subject matter; which is broadly contemplated by the present disclosure. The scope of the present disclosure fully encompasses other embodiments which may become obvious to those skilled in the art, and is to be limited, accordingly, by nothing other than the appended claims, wherein any reference to an element being made in the singular is not intended to mean “one and only one” unless explicitly so stated, but rather “one or more.” All structural and functional equivalents to the elements of the above-described preferred embodiment and additional embodiments as regarded by those of ordinary skill in the art are hereby expressly incorporated by reference and are intended to be encompassed by the present claims.

Moreover, no requirement exists for a system or method to address each and every problem sought to be resolved by the present disclosure, for such to be encompassed by the present claims. Furthermore, no element, component, or method step in the present disclosure is intended to be dedicated to the public regardless of whether the element, component, or method step is explicitly recited in the claims. However, that various changes and modifications in form, material, work-piece, and fabrication material detail may be made, without departing from the spirit and scope of the present disclosure, as set forth in the appended claims, as may be apparent to those of ordinary skill in the art, are also encompassed by the present disclosure.

What is claimed is:

1. A computerized method for limiting an end user's access to interactable elements displayed on a graphical user interface, comprising:
displaying a user interface with interactive elements;
rendering a transparent software surface in front of the user interface that prevents user interaction with interactable elements displayed on the user interface; and
excluding areas in the transparent software surface from preventing the user from interacting with interactable elements displayed on the underlying user interface.

2. The computerized method of claim 1, further comprising:
determining said excluded areas in said transparent software surface prior to displaying said user interface.

3. The computerized method of claim 2, further comprising:
detecting changes in the layout of said user interface,
moving the locations of said excluded areas in said transparent software surface in response to movement in the layout of said user interface prior to displaying said user interface.

4. The computerized method of claim 3, further comprising:
receiving a user interaction input signal;
determining the location of the user interaction input on the display; and
discarding said user interaction input if it is located on the transparent software surface.

5. The computerized method of claim 1, further comprising:
receiving a user interaction input signal;
determining the location of the user interaction input on the display; and
discarding said user interaction input if it is located on the transparent software surface.

6. The computerized method of claim 1, further comprising:
a touch screen display;
a touch screen controller;
determining said excluded areas in said transparent software surface prior to displaying said user interface;
forwarding said excluded areas in said transparent software surface to said touch screen controller;
receiving a user interaction input signal;
determining the location of the user interaction input on the display; and
preventing said touch screen controller from communicating user interaction inputs located in said transparent software surface.

7. The computerized method of claim 6, further comprising:
detecting changes in the layout of said user interface,
moving the locations of said excluded areas in said transparent software surface in response to movement in the layout of said user interface prior to displaying said user interface.

8. The computerized method of claim 1, further comprising:
displaying non-transparent elements on said transparent software surface.

9. The computerized method of claim 8, further comprising:
determining said excluded areas in said transparent software surface prior to displaying said user interface;
detecting changes in the layout of said user interface,
moving the locations of said excluded areas in said transparent software surface in response to movement in the layout of said user interface prior to displaying said user interface.

10. The computerized method of claim 8, wherein said non-transparent elements on said transparent software surface are interactive.

11. In a computer system having a graphical user interface including a display and a method for user interaction with said computer system, a method of preventing user interaction with interactable elements of the user interface, the method comprising:
displaying a user interface with interactive elements;
rendering a transparent software surface in front of the user interface that prevents user interaction with interactable elements displayed on the user interface; and
excluding areas in the transparent software surface from preventing the user from interacting with interactable elements displayed on the underlying user interface.

12. The computer system of claim 11, further comprising:
determining said excluded areas in said transparent software surface prior to displaying said user interface.

13. The computer system of claim 12, further comprising:
detecting changes in the layout of said user interface,
moving the locations of said excluded areas in said transparent software surface in response to movement in the layout of said user interface prior to displaying said user interface.

14. The computer system of claim 13, further comprising:
receiving a user interaction input signal;
determining the location of the user interaction input on the display; and
discarding said user interaction input if it is located on the transparent software surface.

15. The computer system of claim 11, further comprising:
receiving a user interaction input signal;
determining the location of the user interaction input on the display; and
discarding said user interaction input if it is located on the transparent software surface.

16. The computer system of claim 11, further comprising:
a touch screen display;
a touch screen controller;
determining said excluded areas in said transparent software surface prior to displaying said user interface;
forwarding said excluded areas in said transparent software surface to said touch screen controller;
receiving a user interaction input signal;
determining the location of the user interaction input on the display; and
preventing said touch screen controller from communicating user interaction inputs located in said transparent software surface.

17. The computer system of claim 16, further comprising:
detecting changes in the layout of said user interface,
moving the locations of said excluded areas in said transparent software surface in response to movement in the layout of said user interface prior to displaying said user interface.

18. The computer system of claim 11, further comprising:
displaying non-transparent elements on said transparent software surface.

19. The computer system of claim 18, further comprising:
determining said excluded areas in said transparent software surface prior to displaying said user interface;
detecting changes in the layout of said user interface,
moving the locations of said excluded areas in said transparent software surface in response to movement in the layout of said user interface prior to displaying said user interface.

20. The computer system of claim 18, wherein said non-transparent elements on said transparent software surface are interactive.
